(19) United States
(12) Patent Application Publication
(10) Pub. No.: US 2008/0118407 A1
(43) Pub. Date: May 22, 2008

(54) COMMUNICATING COMPARTMENTALIZED FLUIDIZED BED REACTOR

(75) Inventors: John R. Grace, Vancouver (CA); Choon Jim Lim, Vancouver (CA); Alaa-Eldin M. Adris, Giza (EG); Heping Cui, Hamburg (CA); David Anthony Boyd, Vancouver (CA)

Correspondence Address: OYEN, WIGGS, GREEN & MUTALA LLP;480 - THE STATION, 601 WEST CORDOVA STREET, VANCOUVER, BC, V6B 1G1, omitted

(73) Assignee: MEMBRANE REACTOR TECHNOLOGIES LTD., Vancouver (CA)

(21) Appl. No.: 11/941,758

(22) Filed: Nov. 16, 2007

Related U.S. Application Data
(60) Provisional application No. 60/866,247, filed on Nov. 17, 2006.

(51) Int. Cl. B01J 8/18; F27B 15/00

(52) U.S. Cl. 422/141; 422/146; 422/140; 422/139

(57) ABSTRACT

A reactor configuration for fluidized bed reactors in which large exposed fixed surface area per unit reactor volume is required. The configuration uses a serpentine or hairpin bend arrangement of continuously connected and communicating thin channels, with the containing surfaces of these channels being vertical. This configuration enables uniform fluidization of particles throughout the cross-sectional area of the reactor and facilitates dispersal of membrane surfaces, heat transfer surface and baffles in gas-solid fluidized bed reactors.

### FIELD OF THE INVENTION

This invention relates to a novel configuration of fluidized bed reactor. More particularly, it pertains to a fluidized bed reactor which has serpentine or hairpin bend configurations with continuously connected and communicating thin channels, the containing surfaces of the channels being vertical.

### BACKGROUND OF THE INVENTION

Fluidized beds are widely used for a wide range of gas-solid reactions including those where the solid particles act as catalyst particles and those where the particles react with the gas. They are also used in physical processes such as drying of powders, coating of surfaces and heat exchangers.

Since fluidized beds provide favorable bed-to-surface heat transfer and excellent temperature uniformity, they are especially useful for processes where there are high heats of reaction and/or risks of temperature run-away/explosions.

Surfaces in fluidized beds are generally disposed either vertically or horizontally (not obliquely) to achieve the optimum heat transfer characteristics and to maintain favorable gas-solid contacting. For example, many fluidized bed applications involve horizontal or vertical heat transfer tubes immersed in fluidized beds to add or remove heat.

Horizontal surfaces are subject to considerably more wear and to buffeting forces, with the result that vertical surfaces are preferred when minimization of wastage and avoiding buffeting forces are important considerations.

In recent years, interest has grown in compact reactor systems (process intensification) where several operations can be combined in a single vessel. A prime example of this is where perm-selective membranes are immersed in a fluidized bed reactor, creating a fluidized bed membrane reactor, in order to extract hydrogen in situ, hence improving the yield and performance of steam methane reforming reactors. (See Adris et al., U.S. Pat. No. 5,326,550, 1994, Adris et al. papers, and Grace et al. 2005 paper, referred to in the References).

Immersed fixed solid surfaces block or interfere with the movement of solid particles. If surfaces are too close together they can “bridge”, making it impossible for the particles to sustain the motion needed for them to show good fluidization properties. For example, gas mixing, gas-solid contacting and heat transfer can all suffer. In addition, if the surfaces are too close together, this can induce channeling between the adjacent surfaces, which is an undesirable occurrence since the gas then bypasses contact with the particles.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

It has recently been appreciated that it is important to avoid having multiple separate (unconnected) parallel vertical channels in fluidized beds, as these lead to instability, with the flow of both gas and particles distributing themselves non-uniformly in the individual channels (e.g. see Bolthunis et al, 2004; Boyd, 2007 in the References). The new design proposed by the inventors avoids this problem.

The invention constitutes a reactor configuration suitable for fluidized bed reactors requiring large exposed fixed surface area per unit volume. The fixed surfaces may constitute, among others, permeable membranes, heat transfer surfaces, baffles.

The surfaces could also serve a host of applications where high surface-area-to-volume ratio is required and the temperature and composition uniformity of the surroundings is important, such as in coating of surfaces.

It is an objective of the invention to overcome the drawback of having parallel unconnected passages, while providing high vertical fixed surface area and maintaining proper fluidization in all parts of the reactor. The inventors have found, verified in experimental tests in a cold model plastic unit with partitions, that an even gas and particle flow distribution can be maintained if all parallel passages are connected in such a manner that it is possible to travel from one passage to the next in a hairpin bend or serpentine arrangement. Some of the same benefits can be realized by introducing slots for communication between adjacent passages, but the best configuration is one where parallel chambers are connected at alternating ends. We have also shown that pins, supporting the separating walls that form the walls of the chambers which contain the fluidized particles, do not significantly interfere with the chamber-to-chamber communication, and hence with the desired uniformity of gas and solids motion.

A specific objective is to provide an improved reactor configuration for fluidized bed membrane reactors for the pure production of hydrogen by steam methane reforming of hydrocarbons such as, but not limited to, natural gas.

The invention in one aspect is directed to a configuration for disposing a plurality of fixed vertical surfaces inside a fluidized bed wherein gas, particles and pressure signals can communicate (without leaving the bed) within the entire assembly. Vertical surfaces can exchange heat or mass with the fluidized bed.

The invention is also directed to a fluidized bed reactor wherein connected and communicating passages permit the particles to move freely without inducing blockages or gas channeling. The fluidized bed membrane reactor can include partitions. A planar membrane panel can comprise all or most of the partitions. This configuration of a fluidized bed reactor is beneficial for steam reforming of hydrocarbons including, but not limited to natural gas.

In a further embodiment, the invention is directed to a configuration for a fluidized bed reactor in which hydrogen can be extracted from fixed surfaces and withdrawn via tubes or pipes connected to the inside of the panels. In the configuration for the fluidized bed reactor, panels exposed to the fluidized bed on both side faces, as well as on one end, can be inserted into the fluidized bed reactor through slots on one side or multiple sides of the reactor vessel. Such a configuration can be used as a compact heat exchanger for heating or cooling a gas and/or particles, where a heat-transfer-fluid flows through the inside of the panels.

The fluidized bed reactors can include configurations wherein the containing vessel is circular, rectangular, or of other non-square shape in horizontal cross-section. In another aspect, the configuration of fluidized bed reactor with fluidized bed can operate in any one of different well-known hydrodynamic flow regimes of gas-fluidization—bubbling, slug flow, turbulent fluidization or fast fluidization.

In the configuration of fluidized bed reactor, sorbent particles can be added to capture carbon dioxide or other species in order to separate that species from the gas stream. The fluidized bed reactor can include a configuration in which heat is provided by means of direct oxidation inside the fluidized bed or inside the projecting panels. The fluidizing agent can be a liquid rather than a gas. Gas, liquid and particles (three phases) can all be present in the fluidized bed.

In addition to the exemplary aspects and embodiments described above, further aspects and embodiments will become apparent by reference to the drawings and by study of the following detailed descriptions.

### DRAWINGS

Exemplary embodiments are illustrated in referenced figures of the drawings. It is intended that the embodiments and figures disclosed herein are to be considered illustrative rather than restrictive.

FIG. 1(a) illustrates a top view taken along section line AA of FIG. 1(b) of the compartmentalized membrane reactor.

FIG. 1(b) illustrates a front view taken along section line BB of FIG. 1(a) of the compartmentalized membrane reactor.

FIG. 2 is an isometric partial section view of the compartmentalized membrane reactor.

FIG. 3 is a plan section view of the compartmentalized membrane reactor.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

A reactor configuration for fluidized bed reactors in which large exposed fixed surface area per unit reactor volume is required. The configuration uses a serpentine or hairpin bend arrangement of continuously connected and communicating thin channels, with the containing surfaces of these channels being vertical. This configuration enables uniform fluidization of particles throughout the cross-sectional area of the reactor and facilitates dispersal of membrane surfaces, heat transfer surface and baffles in gas-solid fluidized bed reactors, while retaining the usual well-known advantages of fluidized beds.

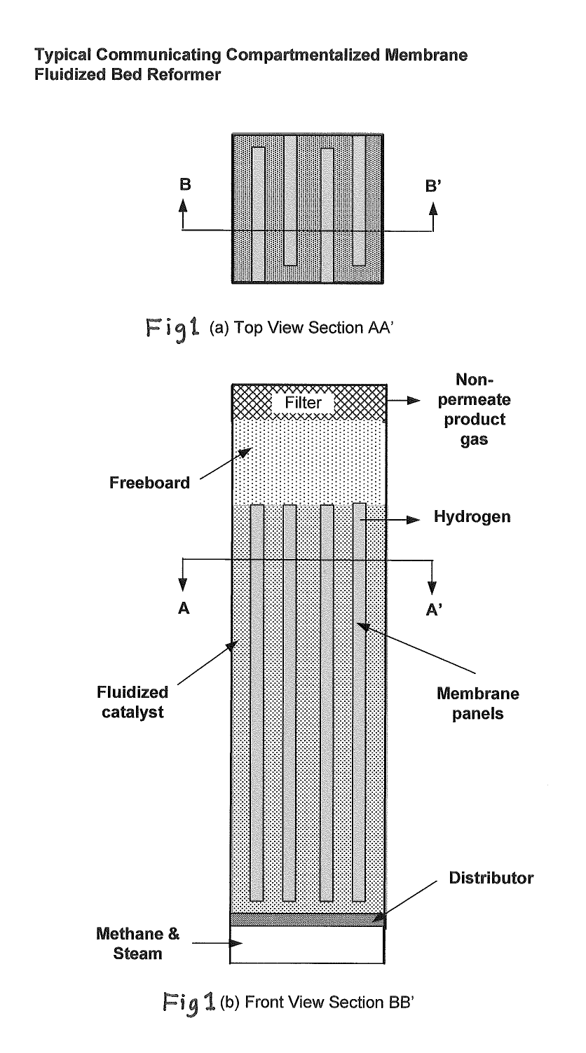

Referring to the drawings, a typical communicating compartmentalized fluidized bed reactor is shown in FIG. 1 in both plan view (FIG. 1(a)) and front view (FIG. 1(b)). In the configuration shown in FIGS. 1(a) and 1(b), there are five vertical parallel chambers separated by four partitions, all contained within a column of square cross-section. Methane and steam are introduced at the bottom. A distributor separates the introduction area from the membrane panels and fluidized catalyst. A freeboard zone is shown above the membrane panels and fluidized catalyst. Non-permeate product gas is expelled through a top filter. Hydrogen is withdrawn from the top of the fluidized catalyst area. The application in this case is for production of pure hydrogen, as taught in the 1994 Adris et al. patent, U.S. Pat. No. 5,326,550. This configuration can be considered an improvement on that patent.

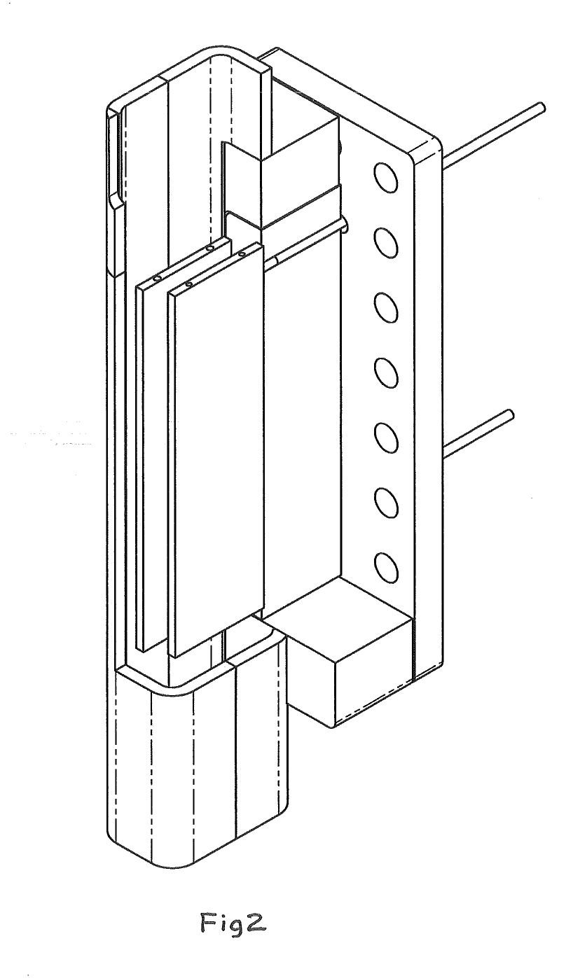

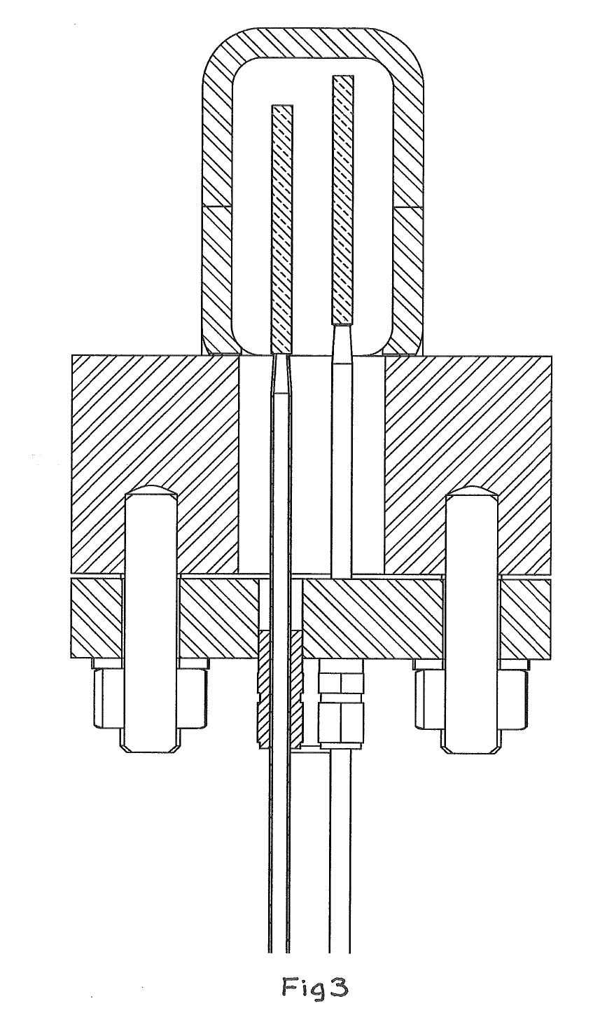

FIG. 2 is an isometric partial section view of the compartmentalized membrane reactor. FIG. 3 is a plan section view of the compartmentalized membrane reactor.

The plurality of communicating parallel channels in the reactor is important. Particles (in this case catalyst) are fluidized in these channels. The walls of the channels are vertical.

Channels are connected so that gas, particles and pressure signals can travel from one channel to all other channels at the same level through the bed, without having to travel through a wall, partition or fixed surface.

The minimum horizontal dimension (thickness) of all channels, including the end “switchbacks” connecting the straight channels, should be at least 20 mean particle diameters.

The fixed solid surfaces may be membrane surfaces, heat transfer surfaces, baffles, solid surfaces for coating or other.

Pins or other mechanical supports may be present at the free ends of panels or flat surfaces to prevent movement and vibration of these surfaces, so long as the pins or other supports do not significantly block the communication of particles, gas and pressure signals.

Fixed vertical surfaces may extend at their lower end down to the distributor plate or start at some distance above the distributor plate. (The latter version is indicated in FIG. 1(b).)

At the upper end, the partitions or fixed vertical surfaces may extend into the freeboard region or terminate within the expanded fluidized bed. (In FIG. 1(b) they are shown as being at the same level as the bed surface.)

The fixed vertical surfaces may be totally impervious, or may allow passage of a gas (as in the membrane reactor case) or they may have perforations or slots through them at one or more levels.

The fluidized bed may operate in the bubbling, slugging, turbulent or fast fluidization hydrodynamic flow regime.

Other features normally found in fluidized beds (such as distributor plates, feed ports, ports for instrumentation, freeboard region (which may expand or contract in cross-section), and gas-solid separation equipment like cyclones and filters) are understood to be included, but are not described, since they are understood to be standard features of fluidized bed reactors and other fluidization equipment by those skilled in the art.

### SPECIFIC EMBODIMENT FOR A STEAM METHANE REFORMING APPLICATION

A series of vertical membrane panels, perm-selective to hydrogen on each side, inserted through sleeves from opposite sides to create a serpentine of parallel communicating channels in which gas can flow upwards, fluidizing catalyst particles whose maximum dimension is on average no more than 5% of the minimum thickness of the flow channel.

Gas which is introduced through the distributor plate is a mixture of steam and hydrocarbon. Solid particles are steam reforming catalyst particles.

Air or oxygen may also be introduced into the reactor to facilitate exothermic oxidation reactions that provide the heat needed by the steam reforming reactions. The outer wall of the vessel may be heated electrically or by a steam.

Some of the panels or surfaces may be blank or be used for heat transfer purposes. The surfaces extend from a few centimetres above the gas distributor plate at the bottom to just below or just above the expanded bed surface.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### REFERENCES

1. Adris, A. M., Grace, J. R., Lim, C. J. and Elnashaie, S. S., Fluidized bed reaction system for steam/hydrocarbon gas reforming to produce hydrogen, U.S. Pat. No. 5,326,550, Jul. 5, 1994.
2. Adris A M and Grace J R, Characteristics of fluidized bed membrane reactors (FBMR)—scale-up and practical issues, Ind. Eng. Chem. Research, 36, 4549-4556 (1997).
3. Adris A M, Lim C J and Grace J R, The fluidized bed membrane reactor (FBMR) system: a pilot scale experimental study, Chem. Eng. Sci., 49, 5833-5843 (1994).
4. Adris A M, Pruden B B, Lim C J and Grace J R, On the reported attempts to radically improve the performance of the steam methane reforming reactor, Can. J. Chem. Eng. 74, 177-186 (1996).
5. Bolthunis, C. O., Silverman, R. W. and Ferrari, D. C., Rocky road to commercialization: breakthroughs and challenges in the commercialization of fluidized bed reactors, in Fluidization X I, ed. U. Arena, R. Chirone, M. Miccio and P. Salatino, Engineering Conferences International, Brooklyn, N.Y., 2004, pp. 547-554.
6. Boyd, D. A., Internally circulating fluidized bed membrane reactor, Ph.D. Thesis, Univ. of British Columbia, 2007.
7. Boyd D T, Grace J R, Lim C J and Adris A M, Hydrogen from an internally circulating fluidized bed membrane reactor, Int. J. Chem. Reactor Engng., 3, A58, 12 pages (2005).
8. Grace J R, Elnashaie S S E H and Lim C J, Hydrogen production in fluidized beds with in-situ membranes. Int. J. Chem. Reaction Engng., vol. 3, A41 (2005).

What is claimed is:

1. A configuration for disposing a plurality of fixed vertical surfaces inside a fluidized bed wherein gas, particles and pressure signals can communicate (without leaving the bed) within the entire assembly.

2. A configuration in which the vertical surfaces can exchange heat or mass with the fluidized bed.

3. A fluidized bed reactor wherein connected and communicating passages permit the particles to move freely without inducing blockages or gas channeling.

4. A configuration for fluidized bed membrane reactors, wherein planar membrane panels comprise all or most of the partitions.

5. A configuration of a fluidized bed reactor which is beneficial for the steam reforming of hydrocarbons including, but not limited to natural gas.

6. A configuration for a fluidized bed reactor in which hydrogen can be extracted from fixed surfaces and withdrawn via tubes or pipes connected to the inside of the panels.

7. A configuration for a fluidized bed reactor whereby panels exposed to the fluidized bed on both side faces, as well as on one end, can be inserted into the fluidized bed reactor through slots on one side or multiple sides of the reactor vessel.

8. A configuration that can be used as a compact heat exchanger for heating or cooling a gas and/or particles, where a heat-transfer-fluid flows through the inside of the panels.

9. Fluidized bed reactors including configurations where the containing vessel is circular, rectangular, or of other non-square shape in horizontal cross-section.

10. A configuration of fluidized bed reactor in which the fluidized bed can operate in any one of different well-known hydrodynamic flow regimes of gas-fluidization—bubbling, slug flow, turbulent fluidization or fast fluidization.

11. A configuration of fluidized bed reactor in which sorbent particles can be added to capture carbon dioxide or other species in order to separate that species from the gas stream.

12. A configuration of fluidized bed reactor in which heat is provided by means of direct oxidation inside the fluidized bed or inside the projecting panels.

13. A configuration of fluidized bed reactor wherein the fluidizing agent is a liquid rather than a gas.

14. A configuration of fluidized bed reactor wherein gas, liquid and particles (three phases) are present in the fluidized bed.
